(19) United States
(12) Patent Application Publication
(10) Pub. No.: US 2023/0159370 A1
(43) Pub. Date: May 25, 2023

(54) CHEMICALLY STRENGTHENED GLASS CERAMIC AND METHOD FOR MANUFACTURING SAME

(71) Applicant: AGC Inc., Tokyo (JP)

(72) Inventors: Takumi UMADA, Tokyo (JP); Hitomi FURUTA, Tokyo (JP); Shusaku AKIBA, Tokyo (JP)

(73) Assignee: AGC Inc., Tokyo (JP)

(21) Appl. No.: 18/159,158

(22) Filed: Jan. 25, 2023

Related U.S. Application Data
(63) Continuation of application No. PCT/JP2021/027603, filed on Jul. 26, 2021.

(30) Foreign Application Priority Data
Jul. 31, 2020 (JP) 2020-130798

(51) Int. Cl. C03B 32/02; C03C 21/00; C03C 10/00

(52) U.S. Cl. CPC C03B 32/02; C03C 21/002; C03C 10/0027; C03C 2204/00

(57) ABSTRACT

The present invention relates to a chemically strengthened glass ceramic including a crystalline phase, having two main surfaces opposed to each other, and including an amorphized region in a surface layer of at least one of the main surfaces and a crystallized region inside the glass, in which the amorphized region has a crystallinity of 10 vol % or less at a depth of 100 nm from an outermost surface of the glass.

### TECHNICAL FIELD

The present invention relates to a chemically strengthened glass ceramic containing a crystalline phase and a method for producing the same.

### BACKGROUND ART

In an electronic device such as a mobile phone or a smartphone, a chemically strengthened glass having a small thickness and high strength is used as a cover glass for protecting a display. As a glass base material subjected to a chemical strengthening treatment, glass ceramics have attracted attention for a purpose of further improving strength.

The glass ceramics are obtained by subjecting an amorphous glass to a heat treatment to precipitate a crystalline phase having high strength in the glass, and have higher strength that an amorphous glass not containing a crystalline phase. Therefore, it is considered that by subjecting the glass ceramics to a chemical strengthening treatment to obtain chemically strengthened glass ceramics, a glass having higher strength than a chemically strengthened glass of the related art can be obtained. For example, Patent Literature 1 describes an example in which glass ceramics are chemically strengthened.

### CITATION LIST

### Patent Literature

Patent Literature 1: JP2016-529201T

### SUMMARY OF INVENTION

### Technical Problem

However, the glass ceramics tend to have deteriorated chemical strengthening properties. This is because the glass ceramics have both a glass phase and a crystalline phase, and ion exchange is less likely to occur in the crystalline phase than in the glass phase. The glass ceramics tend to have a high compressive stress value on a surface after the chemical strengthening treatment, and when the value is too large, an end portion may be chipped after the chemical strengthening treatment. This phenomenon is called chipping.

In view of the above, an object of the present invention is to provide chemically strengthened glass ceramics having excellent chemical strengthening properties and a relaxed surface stress, and a method for producing the same.

### Solution to Problem

The present inventors have performed intensive studies and have found that crystallinity in a vicinity of a main surface of the obtained glass ceramics can be reduced and an amorphized region can be formed by performing a heat treatment in a reducing atmosphere after performing a crystallization treatment on an amorphous glass. Accordingly, ion exchange with a molten salt occurring on a glass surface during the chemical strengthening treatment becomes active, thereby increasing a concentration difference between the amorphized region in the vicinity of the main surface and the inside of the glass ceramics. As a result, a rate of ion diffusion toward the inside of the glass is improved, and chemical strengthening properties of the entire glass ceramics are improved.

Further, by forming the amorphized region in the vicinity of the main surface of the glass ceramics, a glass transition temperature Tg of a surface layer is lower than a glass transition temperature Tg of the inside of the glass ceramics. Therefore, only a compressive stress in the vicinity of the main surface, which does not affect the strength of the entire glass ceramics, is relaxed, and chipping of the chemically strengthened glass ceramics after the chemical strengthening treatment is prevented.

That is, the present invention is as follows.
[1] A chemically strengthened glass ceramic including a crystalline phase,
having two main surfaces opposed to each other, and
including an amorphized region in a surface layer of at least one of the main surfaces and a crystallized region inside the glass,
in which the amorphized region has a crystallinity of 10 vol % or less at a depth of 100 nm from an outermost surface of the glass.

[2] The chemically strengthened glass ceramic according to [1], further including sodium,
in which an absolute value of a sodium concentration difference obtained by |[Na]₀-[Na]_{c}| is 10 mol % or less, where a sodium concentration at a depth of 10 nm from the outermost surface is defined as [Na]₀ (mol %) and a sodium concentration at the depth of 10 nm from the outermost surface, which is calculated by fitting a sodium concentration profile in a region at a depth of 10 μm to 200 μm from the outermost surface to the following formula (1) by a least squares method, is defined as [Na]_{c},

y=A×erfc(x×B)+C (1)
provided that y is a sodium concentration (mol %), x is a depth (μm) from the outermost surface, erfc is a complementary error function, A, B, and C are constants, and x satisfies 0≤x≤200.

[3] The chemically strengthened glass ceramic according to [1] or [2], in which the crystallized region has an average crystallinity of 20 vol % to 80 vol %.

[4] The chemically strengthened glass ceramic according to any one of [1] to [3], in which the amorphized region has a depth of 10 μm or less.

[5] The chemically strengthened glass ceramic according to any one of [1] to [4], in which the outermost surface has a compressive stress value CS₀ of 200 MPa to 900 MPa.

[6] The chemically strengthened glass ceramic according to any one of [1] to [5], in which a depth from the outermost surface at which a compressive stress value CS is maximum is 0.1 μm to 10 μm.

[7] The chemically strengthened glass ceramic according to any one of [2] to [6], in which a sodium ion diffusion depth is (t×0.05) μm to (t×0.2) μm with respect to a thickness t μm of the glass.

[8] The chemically strengthened glass ceramic according to any one of [1] to [7], in which the crystalline phase includes an atom having a first ionization energy of 8 eV or less.

[9] The chemically strengthened glass ceramic according to any one of [1] to [8], further including, in terms of mass % based on oxides:
45% to 75% of SiO₂;
1% to 30% of Al₂O₃;
1% to 25% of Li₂O;
0% to 15% of Na₂O;
0% to 8% of K₂O;
0% to 15% of at least one of SnO₂ and ZrO₂ in total; and
0% to 15% of P₂O₅.

[10] A method for producing a chemically strengthened glass ceramic, the method including followings in order:
preparing an amorphous glass;
subjecting the amorphous glass to a first heat treatment to obtain a glass ceramic including a crystalline phase;
subjecting the glass ceramic to a second heat treatment in a reducing atmosphere to obtain a glass ceramic in which an amorphized region is formed on a surface layer of at least one main surface; and
chemically strengthening the glass ceramic in which the amorphized region is formed.

[11] The method for producing a chemically strengthened glass ceramic according to [10], in which the amorphized region is formed in a region having a depth of 10 μm or less from an outermost surface of the glass, and the amorphized region has a crystallinity of 10 vol % or less at a depth of 100 nm from the outermost surface.

[12] The method for producing a chemically strengthened glass ceramic according to [10] or [11], in which the glass ceramic obtained by the first heat treatment has an average crystallinity of 20 vol % to 80 vol %.

[13] The method for producing a chemically strengthened glass ceramic according to any one of [10] to [12], in which the amorphous glass has a glass transition temperature Tg of 550° C. or less.

[14] The method for producing a chemically strengthened glass ceramic according to any one of [10] to [13], in which a heat treatment temperature T2 (° C.) in the second heat treatment satisfies a relationship of (Tg−200)° C.<T2<(Tg+200)° C. with respect to the glass transition temperature Tg (° C.) of the amorphous glass.

[15] The method for producing a chemically strengthened glass ceramic according to any one of [10] to [14], in which the second heat treatment is performed in a state where carbon is in contact with the glass ceramic.

[16] The method for producing a chemically strengthened glass ceramic according to any one of [10] to [15], in which the glass is formed into a shape having a curved portion during the second heat treatment.

The method for producing a chemically strengthened glass ceramic according to any one of [10] to [16], in which the crystalline phase includes an atom having an ionization energy of 8 eV or less.

The method for producing a chemically strengthened glass ceramic according to any one of [10] to [17], in which the amorphous glass includes, in terms of mass % based on oxides:
45% to 75% of SiO₂;
1% to 30% of Al₂O₃;
1% to 25% of Li₂O;
0% to 15% of Na₂O;
0% to 8% of K₂O;
0% to 15% of at least one of SnO₂ and ZrO2 in total; and
0% to 15% of P₂O₅.

### Advantageous Effects of Invention

According to the present invention, a chemically strengthened glass ceramic having excellent chemical strengthening properties and a relaxed surface stress can be obtained. As a result, it is possible to prevent chipping causing chipping of an end potion after a chemical strengthening treatment while achieving excellent strength properties owing to the chemical strengthening treatment.

### BRIEF DESCRIPTION OF DRAWINGS

FIG. 1 is a transmission electron microscopy (TEM) image of an amorphous glass before being subjected to a first heat treatment in Example 3.

FIG. 2 is a TEM image of glass ceramic obtained after the first heat treatment in Example 3.

FIG. 3 is a TEM image of glass ceramic in which an amorphized region is formed obtained after a second heat treatment in Example 3.

FIG. 4 is a graph showing a relationship between crystallinity and a depth from an outermost surface of chemically strengthened glass ceramic of Example 2.

FIG. 5 is a stress profile of the chemically strengthened glass ceramic of Example 2.

FIG. 6 is a graph showing a relationship between crystallinity and a depth from an outermost surface of chemically strengthened glass ceramic of Example 3.

FIG. 7 is a stress profile of the chemically strengthened glass ceramic of Example 3.

FIG. 8 is a graph showing a relationship between a sodium concentration and a depth from an outermost surface of the chemically strengthened glass ceramic of Example 2.

FIG. 9 is a graph showing a relationship between a sodium concentration and a depth from an outermost surface of the chemically strengthened glass ceramic of Example 3.

### DESCRIPTION OF EMBODIMENTS

Hereinafter, embodiments of the present invention will be described. The present invention is not limited to embodiments described below.

In the present specification, the expression “to” indicating a numerical range is used to include numerical values described therebefore and thereafter as a lower limit value and an upper limit value.

In the present specification, the term “amorphous glass” means a glass in which a diffraction peak showing crystals is not observed by a powder X-ray diffraction method. The term “glass ceramics” means a glass obtained by heat-treating an “amorphous glass” to precipitate a crystalline phase, and contains the crystalline phase.

The term “crystallinity” of the glass means a volume fraction of a crystalline phase contained in the glass. That is, the crystallinity of 0 vol % means that the glass is an amorphous glass that does not contain a crystalline phase but contains only a glass phase, that is, an amorphous phase.

The crystallinity is calculated based on a TEM image of the glass. Specifically, a total area X μm² of crystalline phases present in a range of 1 μm in a direction parallel to a main surface and 0.05 μm in a depth direction is measured based on a TEM image of a target depth portion, and a presence ratio of the crystalline phase calculated by X/0.05 is defined as the crystallinity (vol %).

In the present specification, the term “chemically strengthened glass ceramic” means a glass obtained by subjecting a glass ceramic to a chemical strengthening treatment. Except for a case where an extreme ion exchange treatment is performed, a glass composition of a portion that is deeper than a depth of compressive stress layer (DOL) of chemically strengthened glass ceramics is the same as a glass composition of glass ceramics before the chemical strengthening treatment. Therefore, a base composition of the chemically strengthened glass ceramics and the glass composition of the glass ceramics before the chemical strengthening treatment may be regarded as the same.

Further, a glass composition of an amorphous glass as a raw material and a glass composition of glass ceramics after a crystalline phase is precipitated by a heat treatment may be regarded as the same, and a glass composition of glass ceramics and a glass composition of glass ceramics in which an amorphized region is formed on a surface layer may be regarded as the same.

Therefore, the chemically strengthened glass ceramics according to the present embodiment, the amorphous glass as a raw material thereof, the glass ceramics, and the glass ceramics including the amorphized region may be regarded as having the same glass composition.

In the present specification, the glass composition is expressed in terms of mass % based on oxides unless otherwise specified, and mass % may be simply expressed as “%”. In addition, the phrase “not substantially contained” means that an amount of a component is equal to or lower than a level of an impurity contained in a raw material or the like, that is, the component is not intentionally added. In the present specification, when it is described that a certain component is not substantially contained, a content of the component is specifically, for example, less than 0.1 mass %.

In the present specification, the term “stress profile” means a compressive stress value (CS) with a depth from an outermost surface of a glass as a variable. In the stress profile, a tensile stress is expressed as a negative compressive stress. The compressive stress value at the outermost surface of the glass is represented by CS₀. A maximum compressive stress value is represented by CSₘₐₓ.

In the present specification, the term “sodium ion diffusion depth” is a depth at which a change in sodium concentration is observed, and can be regarded as the same as a depth of compressive stress layer (DOL), which means a depth at which the compressive stress value (CS) is zero, when the sodium ion diffusion depth is small. Specifically, when the depth of compressive stress layer is less than ⅕ of a thickness of the glass, the sodium ion diffusion depth and the depth of compressive stress layer can be regarded as the same. On the other hand, when the depth of compressive stress layer is ⅕ or more of the thickness of the glass, the sodium ion diffusion depth and the depth of compressive stress layer do not coincide with each other. When the sodium ion diffusion depth and the depth of compressive stress layer do not coincide with each other, the sodium ion diffusion depth is determined by measurement using an electron probe microanalyzer (EPMA).

### <Chemically Strengthened Glass Ceramics>

The chemically strengthened glass ceramics according to the present embodiment (hereinafter, also simply referred to as “glass ceramics”) has two main surfaces opposed to each other, and an amorphized region is provided on a surface layer of at least one of the main surfaces. In addition, a crystallized region is provided inside the glass.

In the inside of the glass, crystallinity in a region in which a rate of change in crystallinity is within ±5% is defined as “average crystallinity (vol %) of the crystallized region”. On the other hand, a region exhibiting crystallinity of (average crystallinity of the crystallized region—5 vol %) or more is the crystallized region, and the average crystallinity of the crystallized region is more than 15 vol %.

The amorphized region is a region formed on the surface layer of at least one main surface of the glass ceramics and having crystallinity of 10 vol % or less.

There is a transition region between the crystallized region and the amorphized region. That is, the transition region is a region having crystallinity of more than 10 vol % and less than (the average crystallinity of the crystallized region—5 vol %). However, when the average crystallinity of the crystallized region is just more than 15 vol %, the transition region is too narrow to be recognized, and the crystallized region and the amorphized region may appear to be continuously present.

### (Amorphized Region)

As the amorphized region, crystallinity at a depth of 100 nm from the outermost surface of the glass is 10 vol % or less, preferably 8 vol % or less, and more preferably 5 vol % or less. A lower limit of the crystallinity may be 0 vol %, that is, a crystalline phase may not be contained.

A large amount of glass phase, that is, amorphous phase is present on a surface layer of the glass ceramics, and thus chemical strengthening properties are improved. Specifically, the glass phase has a larger concentration difference between a vicinity of the main surface and the inside of the glass during the chemical strengthening treatment than the crystalline phase, and a rate of ion diffusion toward the inside of the glass is improved. Therefore, the depth of compressive stress layer is also increased, and a deep layer stress tends to be increased.

Since a glass transition temperature Tg of the glass phase is lower than Tg of the crystalline phase, the presence of a large amount of glass phase relaxes a compressive stress of the surface, and can prevent chipping of the glass ceramics after the chemical strengthening treatment.

Further, when a large amount of crystalline phase is contained in the surface layer of the glass ceramics, there is a concern that ion exchange in the crystalline phase proceeds during the chemical strengthening treatment, and an ion exchange amount of a residual glass portion decreases, and thus a compressive stress of the residual glass portion decreases. On the other hand, when a large amount of glass phase is contained, an ion exchange amount of the glass phase increases during the chemical strengthening treatment, and a decrease in the compressive stress of the residual glass portion as described above can be prevented.

This is because, when it is assumed that a total ion exchange amount of the chemical strengthening treatment is constant, the ion exchange amount of the residual glass portion decreases as the ion exchange amount of the crystalline phase increases. That is, when the ion exchange amount of the crystalline phase is large, the ion exchange amount of the residual glass portion is small, and thus it is presumed that a stress generated in the residual glass portion is small.

The amorphized region is present in the glass ceramics, and thus a surface stress is relaxed as described above. Generally, when the surface stress is relaxed, breaking strength in a bending mode decreases. However, the chemically strengthened glass ceramics according to the present embodiment exhibit excellent breaking strength. It is presumed that this is because, a blind scratch is present on the glass surface, and in a region in which the depth from the outermost surface is very small, an influence of the blind scratch is large, and the stress does not significantly affect the breaking strength even if the stress is relaxed.

From the viewpoint of preventing a decrease in breaking strength in the bending mode, the depth of the amorphized region is preferably small, and the depth from the outermost surface of the glass is preferably 10 μm or less, more preferably 8 μm or less, still more preferably 5 μm or less, even more preferably 3 μm or less, yet still more preferably 1 μm or less, particularly preferably 0.5 μm or less, and most preferably 0.3 μm or less.

Further, from the viewpoint of improving chemical strengthening properties, the depth of the amorphized region is 0.1 μm or more, and preferably 0.15 μm or more.

In the chemically strengthened glass ceramics, for example, Li ions in the glass ceramics are ion exchanged with Na ions or K ions, and Na ions in the glass ceramics are ion exchanged with K ions by the chemical strengthening treatment. Among them, the Li ions in the glass ceramics are preferably ion exchanged with the Na ions, and sodium is preferably contained in the glass ceramics.

Regarding the sodium concentration in the amorphized region, a difference between sodium concentrations [Na]₀ (mol %) and [Na]_{c} (mol %), which are obtained by the following two methods, at the depth of 10 nm from the outermost surface is preferably small.

The sodium concentration [Na]₀ at the depth of 10 nm from the outermost surface is a value measured by X-ray photoelectron spectroscopy (XPS).

The sodium concentration [Na]_{c} at the depth of 10 nm from the outermost surface is a value calculated by fitting a sodium concentration profile in a region at a depth of 10 to 200 gm from the outermost surface to the following formula (1) by a least squares method.

In the calculation of the sodium concentration [Na]_{c}, when a thickness t of the glass is 400 μm or less, a region from a depth of 10 μm from the outermost surface to a half of a glass thickness, that is, (t×1/2) μm is targeted. Then, a sodium concentration profile in this region is fitted to the following formula (1) to calculate the sodium concentration [Na]_{c} at the depth of 10 nm from the outermost surface.

y=A×erfc(x×B)+C (1)

(In the formula, y is a sodium concentration (mol %), x is a depth (μm) from the outermost surface, erfc is a complementary error function, A, B, and C are constants, and x satisfies 0≤x≤200.)

An absolute value of a sodium concentration difference expressed by |[Na]₀-[Na]_{c}| using [Na]₀ and [Na]_{c} is preferably 10 mol % or less, more preferably 8 mol % or less, still more preferably 5 mol % or less, even more preferably 2 mol % or less, yet still more preferably 1.5 mol % or less, and particularly preferably 1 mol % or less. A lower limit is not particularly limited, and may be 0, that is, [Na]₀=[Na]_{c}.

In addition, [Na]₀ is preferably ([Na]_{c}×0.5) or more, more preferably ([Na]_{c}×0.7) or more, and still more preferably ([Na]_{c}×0.8) or more, and is preferably ([Na]_{c}×1.5) or less, more preferably ([Na]_{c}×1.4) or less, and still more preferably ([Na]_{c}×1.3) or less, with respect to [Na]_{c}. When [Na]₀ is ([Na]_{c}×1.5) or less, it is possible to prevent a decrease in a compressive stress value CS₅₀ at a depth of 50 μm, which affects drop strength, as a result of an excessive increase in the stress in the outermost layer.

### (Crystallized Region)

The crystallized region is a region showing crystallinity of (the average crystallinity of the crystallized region—5 vol %) or more.

The average crystallinity of the crystallized region is more than 15 vol %, and is preferably 20 vol % or more, more preferably 25 vol % or more, and still more preferably 30 vol % or more, from the viewpoint of relaxing a structure by heat during the chemical strengthening treatment and realizing a more desired stress profile. On the other hand, from the viewpoint of maintaining transparency of the glass, the average crystallinity is preferably 80 vol % or less, more preferably 75 vol % or less, and still more preferably 70 vol % or less.

### (Transition Region)

The transition region is a region that is present between the crystallized region and the amorphized region, and has the crystallinity more than 10 vol % and less than (the average crystallinity of the crystallized region—5 vol %).

The presence of the transition region means that the glass is not a glass ceramic obtained by bonding another amorphous glass or glass ceramics having low crystallinity, which become an amorphized region, to the surface of the glass ceramics. That is, an amorphized region derived from the glass ceramics is formed in a uniform surface layer portion of the glass ceramics by, for example, a heat treatment in a reducing atmosphere, and the transition region is present between the amorphized region and the crystallized region. That is, the crystallinity does not change discontinuously at a boundary between the amorphized region and the crystallized region, but continuously changes, and thus a transition region is present.

The thickness of the transition region varies depending on the average crystallinity of the crystallized region, the thickness of the amorphized region, and the like, and is generally 5 μm or less. Depending on the crystallinity of the crystallized region, the transition region may not be present, and the amorphized region and the crystallized region may be adjacent to each other.

### (Crystalline Phase)

In order to form an amorphized region on the surface layer of the glass ceramics, for example, a heat treatment is performed in a reducing atmosphere. In the amorphization, the ease of being reduced of an atom in a crystal affects the amorphization. Although a redox state is determined by the ionization energy, an easily reduced atom is required to cause the amorphization, and thus the crystalline phase preferably contains an atom having a first ionization energy of 6 eV or more. The crystalline phase more preferably contains an atom having a first ionization energy of 6.5 eV or more, still more preferably contains an atom having a first ionization energy of 7 eV or more, and still more preferably contains an atom having a first ionization energy of 7.5 eV or more. An upper limit of the first ionization energy of the easily reduced atom is not particularly limited, and is generally 14 eV or less.

Further, in order to prevent the occurrence of coloring due to excessive reduction, the crystalline phase preferably contains an atom having a first ionization energy of 9 eV or less at the same time in addition to the easily reduced atom. The crystalline phase more preferably contains an atom having a first ionization energy of 8 eV or less at the same time, still more preferably contains an atom having a first ionization energy of 7 eV or less at the same time, and yet still more preferably contains an atom having a first ionization energy of 6.5 eV or less at the same time. A lower limit of the first ionization energy of the atom is not particularly limited, and is generally 4 eV or more.

Specific examples of the easily reduced atom having the first ionization energy of 6 eV or more include Si (8.2 eV), P (10.5 eV), Mg (7.7 eV), and the like. Among them, Si and P are preferably contained. Specific examples of the atom that has the first ionization energy of 9 eV or less and prevents the occurrence of excessive reduction include Li (5.4 eV), Na (5.2 eV), K (4.4 eV), and Al (6.0 eV). Among them, Li and Na are preferably contained.

Preferable examples of crystals for constituting a crystalline phase containing these atoms include a lithium aluminosilicate crystal and a lithium silicate crystal. When the lithium aluminosilicate crystal or the lithium silicate crystal is contained, these crystals are also subjected to ion exchange by the chemical strengthening treatment, and thus high strength is obtained.

Examples of the lithium aluminosilicate crystal include a β-spodumene crystal (LiAlSi₂O₆) and a petalite crystal (LiAlSi₄O₁₀) Examples of the lithium silicate crystal include a lithium metasilicate crystal (Li₂SiO₃) and a lithium disilicate crystal (Li₂Si₂O₅).

These crystals can be selected according to a purpose, and for example, when it is desired to increase the strength after the chemical strengthening treatment, the β-spodumene crystal is preferably contained. When it is desired to improve transparency and formability while maintaining chemical strengthening properties, the lithium metasilicate crystal is preferably contained. When it is desired to lower a bending forming temperature, the petalite crystal or the lithium metasilicate crystal is preferably contained.

An average grain size of crystalline phases is preferably 300 nm or less, more preferably 200 nm or less, still more preferably 150 nm or less, and particularly preferably 100 nm or less, from the viewpoint of maintaining the transparency of the glass. The average grain size of precipitated crystals can be calculated based on a powder X-ray diffraction intensity by a Rietveld method.

### (Physical Properties)

Since the Tg of the amorphized region is lower than the Tg of the crystallized region, the chemically strengthened glass ceramics according to the present embodiment tend to have a smaller compressive stress value CS₀ of the outermost surface, compared to the chemically strengthened glass ceramics in which the amorphized region is not present.

That is, the compressive stress value CS₀ of the outermost surface is preferably lower than a maximum value CSₘₐₓ of the compressive stress value of the glass ceramics.

The compressive stress value CS₀ of the outermost surface in which the amorphized region is present varies depending on conditions of the chemical strengthening treatment, the glass composition, and the like, and thus cannot be uniformly defined. However, the compressive stress value CS₀ is preferably 200 MPa or more, more preferably 230 MPa or more, and still more preferably 250 MPa or more, from the viewpoint of obtaining excellent breaking strength of the glass ceramics. On the other hand, in consideration of the stress relaxation of the amorphized region, the compressive stress is lower than an effect of the chemical strengthening treatment on the crystallized region. Therefore, in consideration of an effect of the presence of the amorphized region, from the viewpoint of preventing chipping, the compressive stress value CS₀ of the outermost surface is preferably 900 MPa or less, more preferably 850 MPa or less, and still more preferably 800 MPa or less.

When a maximum value of the compressive stress value is CSₘₐₓ, the compressive stress value CS₀ of the outermost surface is preferably (CSₘₐₓ×0.2) MPa or more, more preferably (CSₘₐₓ×0.3) MPa or more, and still more preferably (CSₘₐₓ×0.4) MPa or more, from the viewpoint of obtaining excellent breaking strength of the glass ceramics. In consideration of the effect of the presence of the amorphized region, from the viewpoint of preventing chipping, the compressive stress value CS₀ of the outermost surface is preferably (CSₘₐₓ×0.9) MPa or less, more preferably (CSₘₐₓ×0.8) MPa or less, and still more preferably (CSₘₐₓ×0.7) MPa or less.

In consideration of the presence of the amorphized region, the depth from an outermost surface at which the maximum value CSₘₐₓ of the compressive stress value is obtained is preferably 0.1 μm or more, more preferably 0.3 μm or more, and still more preferably 0.5 μm or more, and is preferably 10 μm or less, more preferably 8 μm or less, and still more preferably 6 μm or less.

The maximum value CSₘₐₓ of the compressive stress value varies depending on conditions of the chemical strengthening treatment, the glass composition, and the like, and thus cannot be uniformly defined. However, the maximum value CSₘₐₓ is preferably 500 MPa or more, more preferably 600 MPa or more, and still more preferably 800 MPa or more, from the viewpoint of making the glass less apt to crack due to deformation such as deflection. An upper limit of the maximum value CSₘₐₓ of the compressive stress value is not particularly limited, and is, for example, 1500 MPa or less.

Four-point bending strength of the glass ceramics is greatly affected by the blind scratch on the glass surface. Therefore, as for the correlation with the four-point bending strength, a compressive stress value at a depth of several gm from the outermost surface is higher than the compressive stress value CS₀ of the outermost surface. As an example of an index thereof, a compressive stress value CS₅ at a depth of 5 μm from the outermost surface may be adopted. CS₅ is preferably 600 MPa or more, and more preferably 650 MPa or more, from the viewpoint of obtaining high bending strength. An upper limit of CS₅ is not particularly limited, and is, for example, 1300 MPa or less.

As the drop strength of the glass ceramics, a compressive stress value at a certain depth from the outermost surface may be used as an index. As an example, when the compressive stress value CS₅₀ at the depth of 50 μm from the outermost surface is used, CS₅₀ is preferably 110 MPa or more, more preferably 150 MPa or more, and still more preferably 200 MPa or more from the viewpoint of obtaining high drop strength. An upper limit of CS₅₀ is not particularly limited, and is, for example, 300 MPa or less.

Lithium ions in the glass ceramics are preferably exchanged with sodium ions by the chemical strengthening treatment. In this case, the sodium ion diffusion depth is preferably (t×0.05) μm or more, more preferably (t×0.08) μm or more, and still more preferably (t×0.1) μm or more, with respect to the thickness t μm of the glass, from the viewpoint of making the glass less apt to crack when scratches are formed on the glass surface. Further, from the viewpoint of preventing explosive fracture at the time of receiving damage due to an excessive tensile stress, the sodium ion diffusion depth is preferably (t×0.2) μm or less, more preferably (t×0.18) gm or less, and still more preferably (t×0.15) μm or less.

When the lithium ions in the glass ceramics are not exchanged with the sodium ions, the depth of compressive stress layer (DOL) preferably satisfies the above range.

The thickness t of the chemically strengthened glass ceramics is not particularly limited, but is preferably 200 μm or more, more preferably 300 μm or more, and still more preferably 400 μm or more from the viewpoint of obtaining strength necessary for a cover glass. In view of the form of use as a cover glass, the thickness is preferably 2 mm or less, more preferably 1.5 mm or less, and still more preferably 1 mm or less.

The chemically strengthened glass ceramics may have a flat sheet shape or a shape having a curved portion.

The shape having a curved portion means a three-dimensional shape obtained by bending a flat sheet. The three-dimensional shape is not limited to a shape in which the entire thickness is uniform, and may have portions having different thicknesses.

As the shape having a curved portion, for example, a central portion of the main surface may have a flat sheet shape and a pair of opposing end portions may have a concave shape or a convex shape, or the entire glass may have a curved surface shape. In addition, the glass may have a shape constituted by a plurality of R shapes.

The four-point bending strength of the chemically strengthened glass ceramics is preferably 500 MPa or more, more preferably 550 MPa or more, and still more preferably 600 MPa or more. The four-point bending strength is measured using a test piece of 40 mm×5 mm×0.7 mm under the following conditions: a lower span, that is, a distance between outer fulcrums of a holder is 30 mm; an upper span, that is, a distance between inner fulcrums is 10 mm; and a crosshead speed is 0.5 mm/min. The measurement is performed on ten test pieces, and an average value of the obtained results is defined as the four-point bending strength.

The drop strength of the chemically strengthened glass ceramics is preferably 100 cm or more, more preferably 120 cm or more, and still more preferably 150 cm or more. The drop strength is measured using a test piece of 120 mm×60 mm×0.7 mm, which is regarded as a cover glass of a smartphone. Specifically, the test piece is attached to a housing that simulates a smartphone, and is dropped onto a flat surface on which 180 grit sandpaper is placed. At this time, the total mass of the test piece and the housing is about 140 g. A drop test is started from a height of 30 cm, and when a glass sheet as the test piece does not break, the drop test is repeated by increasing the height by 10 cm, and a height when the glass sheet breaks is recorded. The test is counted as one set, 10 sets are repeated, and an average value of heights when the glass sheet breaks is defined as the drop strength.

### (Glass Composition)

A glass composition of the chemically strengthened glass ceramics preferably includes, in terms of mass % based on oxides:
45% to 75% of SiO₂;
1% to 30% of Al₂O₃;
1% to 25% of Li₂O;
0% to 15% of Na₂O;
0% to 8% of K₂O;
0% to 15% of at least one of SnO₂ and ZrO₂ in total; and
0% to 15% of P₂O₅.

As described above, the chemically strengthened glass ceramics according to the present embodiment, and the amorphous glass as a raw material thereof, the glass ceramics, and the glass ceramics including the amorphized region may be regarded as having the same glass composition, and preferred ranges thereof are also the same.

The preferred embodiment of the glass composition varies depending on crystals constituting the crystalline phase.

For example, when the crystalline phase contains a lithium aluminosilicate crystal, the glass composition more preferably contains, in terms of mass % based on oxides: 58% to 74% of SiO2; 5% to 30% of A1₂0₃; 1% to 14% of Li2O; 0% to 5% of Na2O; 0% to 2% of K₂O; 0.5% to 12% of at least one of SnO₂ and ZrO₂ in total; and 0% to 6% of P₂O₅.

When the crystalline phase contains a lithium silicate crystal, the glass composition preferably includes, in terms of mass % based on oxides: 45% to 75% of SiO2; 1% to 20% of Al₂O₃; 10% to 25% of Li₂O; 0% to 10% of Na₂O; 0% to 5% of K₂O; 0% to 15% of ZrO₂; and 0% to 12% of P₂O₅.

Hereinafter, each component will be described.

SiO₂ is a component that forms a network structure of a glass. In addition, SiO₂ a component that increases chemical durability, and is also a constituent component of the crystalline phase. Si atoms constituting SiO₂ have a high first ionization energy of 8.2 eV and are easily reduced. The content of SiO₂ is preferably 45% or more, more preferably 50% or more, and still more preferably 55% or more. Particularly, when it is desired to increase the strength, the content of SiO₂ is more preferably 58% or more, still more preferably 60% or more, and yet still more preferably 64% or more. On the other hand, from the viewpoint of obtaining good meltability, the content of SiO₂ is preferably 75% or less, more preferably 74% or less, still more preferably 70% or less, yet still more preferably 68% or less, and particularly preferably 66% or less.

Al₂O₃ is a component effective for increasing a surface compressive stress due to chemical strengthening. In addition, Al₂O₃ is also a constituent component of the crystalline phase. Al atoms constituting Al₂O₃ have a low first ionization energy of 6.0 eV and prevent excessive reduction. The content of Al₂O₃ is preferably 1% or more, more preferably 2% or more, still more preferably 5% or more, and yet still more preferably 8% or more. When it is desired to precipitate a β-spodumene crystal, the content of Al₂O₃ is more preferably 15% or more, and still more preferably 20% or more. On the other hand, from the viewpoint of preventing an increase in devitrification temperature of the glass ceramics, the content of Al₂O₃ is preferably 30% or less, and more preferably 25% or less. In order to lower a forming temperature, the content of Al₂O₃ is more preferably 20% or less, and still more preferably 15% or less.

Li₂O is a component that forms a surface compressive stress by ion exchange, and is also a constituent component of the crystalline phase. Li atoms constituting Li₂O have a low first ionization energy of 5.4 eV and prevent excessive reduction. The content of Li2O is preferably 1% or more, more preferably 2% or more, and still more preferably 4% or more.

In order to increase the precipitation amount of the lithium metasilicate crystal as the crystalline phase, the content of Li₂O is more preferably 10% or more, still more preferably 15% or more, and particularly preferably 20% or more. In this case, the content of Li₂O is preferably 25% or less, more preferably 22% or less, and still more preferably 20% or less.

When the lithium aluminosilicate crystal is precipitated as the crystalline phase, the content of Li₂O is preferably 14% or less, and when the β-spodumene crystal is precipitated, the content of Li₂O is preferably 10% or less, more preferably 8% or less, and still more preferably 6% or less.

When the β-spodumene crystal is contained as the crystalline phase, a content ratio of Li₂O and Al₂O₃ represented by Li₂O/Al₂O₃ is preferably 0.3 or less because the transparency is increased.

Na₂O is a component that improves the meltability of the glass. Na atoms constituting Na₂O have a low first ionization energy of 5.2 eV and prevent excessive reduction. Na₂O may not be contained, but in a case where Na₂O is contained, the content of Na₂O is preferably 0.5% or more, and more preferably 1% or more. On the other hand, the content of Na2O is preferably 15% or less, more preferably 12% or less, and still more preferably 10% or less, from the viewpoint of easily precipitating a crystalline phase and obtaining good chemical strengthening properties. In order to precipitate the β-spodumene crystal as the crystalline phase, the content of Na₂O is preferably 5% or less, more preferably 4% or less, and still more preferably 3% or less.

K₂O is a component that lowers a melting temperature of the glass similarly to Na₂O, and may be contained. In a case where K₂O is contained, the content of K₂O is preferably 0.5% or more, and more preferably 1% or more. From the viewpoint of lowering the forming temperature, the content of K₂O is more preferably 1.5% or more, and still more preferably 2% or more.

A total content of Na₂O and K₂O represented by Na₂O+K₂O is preferably 1% or more, and more preferably 2% or more.

On the other hand, from the viewpoint of obtaining good chemical strengthening properties, the content of K₂O is preferably 8% or less, more preferably 7% or less, still more preferably 6% or less, particularly preferably 5% or less.

From the viewpoint of facilitating precipitation of the lithium aluminosilicate crystal as the crystalline phase, the content of K₂O is preferably 2% or less. In this case, the total content of Na₂O and K₂O represented by Na₂O+K₂O is preferably 5% or less, more preferably 4% or less, and still more preferably 3% or less from the viewpoint of preventing a decrease in transparency during the heat treatment and increasing the transparency.

From the viewpoint of obtaining good chemical strengthening properties while precipitating the lithium metasilicate crystal as the crystalline phase, the content of K₂O is preferably 4% or less, more preferably 3% or less, and particularly preferably 2% or less.

Although neither ZrO₂ nor SnO₂ is essential, ZrO₂ and SnO₂ are components constituting crystal nuclei in a crystallization treatment, and preferably contain at least one of ZrO₂ and SnO₂. A total content of SnO₂ and ZrO₂ represented by SnO_{2 +}ZrO₂ is preferably 0.5% or more, and more preferably 1% or more from the viewpoint of crystal nucleation. From the viewpoint of increasing the transparency by forming a large number of crystal nuclei, the total content is preferably 3% or more, more preferably 4% or more, still more preferably 5% or more, particularly preferably 6% or more, and most preferably 7% or more.

On the other hand, from the viewpoint of preventing devitrification during glass melting, the total content of SnO₂ and ZrO₂ is preferably 15% or less, and more preferably 14% or less. From the viewpoint of making defects due to unmelted materials less likely to occur in the glass, the total content is preferably 12% or less, more preferably 10% or less, still more preferably 9% or less, and particularly preferably 8% or less.

From the viewpoint of facilitating precipitation of the lithium metasilicate crystal as the crystalline phase, ZrO₂ is preferably contained. In this case, the content of ZrO₂ is preferably 1% or more, more preferably 2% or more, still more preferably 4% or more, particularly preferably 6% or more, and most preferably 7% or more. On the other hand, from the viewpoint of preventing devitrification during melting, the content of ZrO₂ is preferably 15% or less, more preferably 14% or less, still more preferably 12% or less, and particularly preferably 11% or less.

From the viewpoint of facilitating precipitation of the β-spodumene crystal as the crystalline phase, SnO₂ is preferably contained. In this case, the content of SnO₂ is preferably 0.5% or more, more preferably 1% or more, and still more preferably 1.5% or more. On the other hand, from the viewpoint of making defects due to unmelted materials less likely to occur in the glass ceramics, the content of SnO₂ is preferably 6% or less, more preferably 5% or less, and still more preferably 4% or less.

From the viewpoint of facilitating precipitation of the β-spodumene crystal as the crystalline phase, ZrO₂ is preferably contained. In this case, the content of ZrO₂ is preferably 0.5% or more, and more preferably 1% or more. Further, from the viewpoint of preventing devitrification during melting and maintaining the quality of the resulting glass ceramics, the content of ZrO₂ is preferably 6% or less, more preferably 5% or less, and still more preferably 4% or less.

In a case where it is desired to precipitate the β-spodumene crystal as the crystalline phase, when both SnO₂ and ZrO₂ are contained, a ratio of the content of SnO₂ to the total content of SnO₂ and ZrO₂ represented by SnO₂/(SnO₂+ZrO₂) is preferably 0.3 or more, more preferably 0.35 or more, and still more preferably 0.45 or more from the viewpoint of increasing the transparency. On the other hand, from the viewpoint of increasing the strength, the ratio is preferably 0.7 or less, more preferably 0.65 or less, and still more preferably 0.60 or less.

SnO₂ is also a component that enhances solarization resistance. From the viewpoint of preventing solarization, the content of SnO₂ is preferably 1% or more, and more preferably 1.5% or more.

TiO₂ is a crystal nucleation component of the glass ceramics.

From the viewpoint of facilitating precipitation of the β-spodumene crystal as the crystalline phase, in a case where TiO₂ is contained, the content of TiO₂ is preferably 0.1% or more, more preferably 0.15% or more, and still more preferably 0.2% or more. On the other hand, from the viewpoint of preventing devitrification during melting and maintaining the quality of the resulting glass ceramics, the content of TiO₂ is preferably 5% or less, more preferably 3% or less, and still more preferably 1.5% or less.

From the viewpoint of facilitating precipitation of the lithium metasilicate crystal as the crystalline phase, in a case where TiO₂ is contained, the content of TiO₂ is preferably 0.5% or more, more preferably 1% or more, still more preferably 2% or more, particularly preferably 3% or more, and most preferably 4% or more. On the other hand, from the viewpoint of preventing devitrification during melting and maintaining the quality of the resulting glass ceramics, the content of TiO₂ is preferably 10% or less, more preferably 8% or less, and still more preferably 6% or less.

Fe₂O₃ is a component that may be generally contained as an impurity in the glass ceramics. In a case where Fe₂O₃ is contained, when the glass ceramics contain TiO₂, a composite called an ilmenite composite is formed, and yellow or brown coloring is likely to occur. From the viewpoint of preventing such coloring, the content of TiO₂ is preferably 1% or less, more preferably 0.5% or less, still more preferably 0.25% or less, and it is particularly preferable that TiO₂ is not substantially contained.

P₂O₅ is not essential, but has an effect of promoting phase separation of the glass to promote crystallization, and may be contained. P atoms constituting P₂O₅ have a high first ionization energy of 10.5 eV and are easily reduced. When P₂O₅ is contained, the content of P₂O₅ is preferably 0.1% or more, more preferably 0.5% or more, still more preferably 1% or more, and particularly preferably 2% or more.

From the viewpoint of facilitating precipitation of the lithium metasilicate crystal as the crystalline phase, the content of P₂O₅ is more preferably 4% or more, still more preferably 5% or more, and particularly preferably 6% or more. On the other hand, from the viewpoint of maintaining good acid resistance, the content of P2O5 is preferably 15% or less, more preferably 14% or less, still more preferably 12% or less, even more preferably 11% or less, yet still more preferably 10% or less, particularly preferably 8% or less, and most preferably 7% or less.

When the β-spodumene crystal is contained as the crystalline phase, the content of P₂O₅ is preferably 6% or less, more preferably 5% or less, still more preferably 4% or less, particularly preferably 3% or less, and most preferably 2% or less, from the viewpoint that broken pieces are less likely to scatter when the glass ceramics are broken. When the acid resistance is regarded as important, it is preferable that P₂O₅ is not substantially contained.

B₂O₃ is a component that improves chipping resistance and meltability, and may be contained. In a case where B₂O₃ is contained, in order to improve the meltability, the content of B₂O₃ is preferably 0.5% or more, more preferably 1% or more, and still more preferably 2% or more. On the other hand, from the viewpoint of preventing the occurrence of striae during melting and maintaining the quality of the resulting glass ceramics, the content of B₂O₃ is preferably 5% or less, more preferably 4% or less, still more preferably 3% or less, and particularly preferably 1% or less. When the acid resistance is regarded as important, it is preferable that B₂O₃ is not substantially contained.

MgO is a component that increases the surface compressive stress value of the glass ceramics, and may be contained in order to prevent scattering of broken pieces when the glass ceramics are broken. In a case where MgO is contained, the content of MgO is preferably 0.5% or more, and more preferably 1% or more. On the other hand, from the viewpoint of preventing devitrification during melting, the content of MgO is preferably 5% or less, more preferably 4% or less, and still more preferably 3% or less.

CaO is a component that improves the meltability of the glass, and may be contained in order to prevent devitrification during melting and improve the meltability while preventing an increase in a thermal expansion coefficient. In a case where CaO is contained, the content of CaO is preferably 0.5% or more, and more preferably 1% or more. On the other hand, from the viewpoint of increasing ion exchange properties, the content of CaO is preferably 4% or less, more preferably 3% or less, and particularly preferably 2% or less.

SrO is a component that improves the meltability of the glass, and is also a component that improves light transmittance of the glass ceramics by improving a refractive index of the glass and bringing refractive indices of the glass phase and the crystalline phase after crystallization close to each other. In a case where SrO is contained, the content of SrO is preferably 0.1% or more, more preferably 0.5% or more, and still more preferably 1% or more. On the other hand, from the viewpoint of preventing an ion exchange rate from excessively decreasing, the content of SrO is preferably 3% or less, more preferably 2.5% or less, still more preferably 2% or less, and particularly preferably 1% or less.

BaO is a component that improves the meltability of the glass, and is also a component that improves light transmittance of the glass ceramics by improving a refractive index of the glass and bringing refractive indices of the glass phase and the crystalline phase after crystallization close to each other. In a case where BaO is contained, the content of BaO is preferably 0.1% or more, more preferably 0.5% or more, and still more preferably 1% or more. On the other hand, from the viewpoint of preventing an ion exchange rate from decreasing excessively, the content of BaO is preferably 3% or less, more preferably 2.5% or less, still more preferably 2% or less, and particularly preferably 1% or less.

ZnO is a component that decreases the thermal expansion coefficient of the glass ceramics and increases the chemical durability. ZnO is also a component that improves light transmittance of the glass ceramics by improving a refractive index of the glass and bringing refractive indices of the glass phase and the crystalline phase after crystallization close to each other. In a case where ZnO is contained, the content of ZnO is preferably 0.5% or more, more preferably 1% or more, still more preferably 1.5% or more, and particularly preferably 2% or more. On the other hand, from the viewpoint of preventing devitrification during melting, the content of ZnO is preferably 4% or less, more preferably 3% or less, and still more preferably 2% or less.

Y₂O₃, La₂O₃, Nb₂O₅, and Ta₂O₅ all have an effect of preventing scattering of broken pieces when the glass ceramics are broken, and are components that increase the refractive index. When these components are contained, a total content of Y₂O₃, La₂O₃, and Nb₂O₅ represented by Y₂O₃+La₂O₃+Nb₂O₅ is preferably 0.5% or more, more preferably 1% or more, still more preferably 1.5% or more, and particularly preferably 2% or more. From the viewpoint of preventing devitrification of the glass during melting, the total content is preferably 4% or less, more preferably 3% or less, still more preferably 2% or less, and particularly preferably 1% or less.

A total content of Y₂O₃, La₂O₃, Nb₂O₅, represented by Y₂O₃+La₂O₃+Nb₂O₅+Ta₂O_{O} is preferably 0.5% or more, more preferably 1% or more, still more preferably 1.5% or more, and particularly preferably 2% or more. From the viewpoint of preventing devitrification of the glass during melting, the total content is preferably 4% or less, more preferably 3% or less, still more preferably 2% or less, and particularly preferably 1% or less.

CeO₂ has an effect of oxidizing the glass, and may prevent SnO₂ from being reduced to become SnO as a coloring component and preventing coloring when SnO₂ is contained in a large amount. In a case where CeO₂ is contained, the content of CeO₂ is preferably 0.03% or more, more preferably 0.05% or more, and still more preferably 0.07% or more. On the other hand, from the viewpoint of preventing coloring of the glass ceramics and obtaining high transparency, the content of CeO₂ is preferably 1.5% or less, and more preferably 1.0% or less.

In addition to the above, a coloring component may be added within a range that does not inhibit the expression of a desired effect. Examples of the coloring component include Co₃O₄, MnO₂, Fe₂O₃, NiO, CuO, Cr₂O₃, V₂O₅, Bi₂O₃, SeO₂, Er₂O₃, and Nd₂O₃.

The content of the coloring component is preferably 1% or less in total, and when it is desired to further increase light transmittance of the glass ceramics, it is preferable that these components are not substantially contained.

SO₃, a chloride, a fluoride, or the like may be appropriately contained as a refining agent during melting of the glass. It is preferable that As₂O₃ is not substantially contained. In a case where Sb₂O₃ is contained, the content of Sb₂O₃ is preferably 0.3% or less, more preferably 0.1% or less, and it is most preferable that Sb₂O₃ is not substantially contained.

### <Method for Producing Chemically Strengthened Glass Ceramics>

In a method for producing chemically strengthened glass ceramics according to the present embodiment, the following steps (a) to (d) are performed in order.

Step (a): preparing an amorphous glass;

Step (b): subjecting the amorphous glass in step (a) to a first heat treatment to obtain a glass ceramic containing a crystalline phase;

Step (c): subjecting the glass ceramic obtained in step (b) to a second heat treatment in a reducing atmosphere to obtain a glass ceramic in which an amorphized region is formed on a surface layer of at least one main surface; and

Step (d): chemically strengthening the glass ceramic obtained in step (c) in which the amorphized region is formed.

Each step will be described in order.

(Step (a))

The amorphous glass can be produced by a generally known method.

For example, when a sheet-shaped amorphous glass is obtained, the amorphous glass can be produced by the following method.

Glass raw materials are blended to obtain an amorphous glass having a desired composition, and are heated and melted in a glass melting furnace. Thereafter, the molten glass is homogenized by bubbling, stirring, addition of a refining agent, or the like, formed into a glass sheet having a predetermined thickness by a known forming method, and annealed. After the molten glass is homogenized, the molten glass may be formed into a sheet shape by a method of forming the molten glass into a block shape, followed by annealing and cutting.

Examples of a method of forming a sheet-shaped glass include a float method, a press method, a fusion method, and a down-draw method. Particularly, when a large-sized glass sheet is produced, the float method is preferable. In addition, a continuous forming method other than the float method, such as a fusion method and a down-draw method, is also preferable.

The glass composition of the amorphous glass may be, for example, a composition described in the (glass composition) of the <chemically strengthened glass ceramics>, and preferred embodiments are also the same.

It is also preferable to select the glass composition of the amorphous glass so that a desired crystalline phase is contained in the glass ceramics obtained in the subsequent step (b).

The glass transition temperature Tg of the amorphous glass is not particularly limited, but is preferably 600° C. or lower, more preferably 580° C. or lower, and still more preferably 550° C. or lower from the viewpoint of facilitating structural relaxation during the chemical strengthening treatment. Since a melting point of sodium nitrate is around 380° C., the glass transition temperature Tg is preferably 450° C. or higher.

(Step (b))

By performing a first heat treatment on the amorphous glass prepared in step (a), glass ceramics containing a crystalline phase are obtained.

The first heat treatment is not particularly limited as long as a crystalline phase is formed, but from the viewpoint of generating a large number of crystal nuclei and performing good crystal growth, it is preferable to perform a heat treatment including two or more stages.

In a case of performing a two-stage heat treatment, for example, the temperature is preferably increased from room temperature to a first-stage heat treatment temperature, and the amorphous glass is held for a certain period of time, and then the amorphous glass is held for a certain period of time at a second-stage heat treatment temperature that is higher than the first-stage heat treatment temperature.

In a case of performing a three-stage heat treatment, for example, in addition to the two-stage heat treatment, the glass is further held for a certain period of time at a third-stage heat treatment temperature that is higher than the second-stage heat treatment temperature.

In the case of the two-stage heat treatment, the first-stage heat treatment temperature is preferably a temperature range in which a crystal nucleation rate increases in the glass composition, and the second-stage heat treatment temperature is preferably a temperature range in which the crystal growth rate increases in the glass composition.

A holding time at the first-stage heat treatment temperature is preferably kept long so that a sufficient number of crystal nuclei are generated. When a large number of crystal nuclei are generated, the size of each crystal is reduced, and glass ceramics having high transparency are obtained.

The first-stage heat treatment temperature in the first heat treatment is, for example, 550° C. or more and 800° C. or less. The second-stage heat treatment temperature in the first heat treatment is, for example, 850° C. or more and 1000° C. or less.

After the amorphous glass is held at the first-stage heat treatment temperature for, for example, 2 hours to 10 hours, the amorphous glass is held at the second-stage heat treatment temperature for, for example, 2 hours to 10 hours.

The crystallinity of the glass ceramics obtained by the first heat treatment is more than 15 vol %. From the viewpoint of relaxing a structure by heat during the chemical strengthening treatment in step (d) and realizing a more desired stress profile, the crystallinity of the glass ceramics is preferably 20 vol % or more, more preferably 25 vol % or more, and still more preferably 30 vol % or more. On the other hand, from the viewpoint of maintaining the transparency of the glass ceramics, the crystallinity is preferably 90 vol % or less, and more preferably 80 vol % or less.

The average crystallinity of the glass ceramics can be set to a desired value depending on the heat treatment temperature and the heat treatment time in the first heat treatment. The average crystallinity inside the glass ceramics does not change even after the subsequent step (c) of forming an amorphized region on a surface layer of the glass ceramics. The same applies to the case where the chemical strengthening treatment is performed in step (d).

Therefore, the average crystallinity of the glass ceramics obtained in step (b) is the same as the average crystallinity of the chemically strengthened glass ceramics.

(Step (c))

By subjecting the glass ceramics obtained in step (b) to a second heat treatment in a reducing atmosphere, glass ceramics are obtained in which an amorphized region is formed on a surface layer of at least one main surface.

The second heat treatment is not particularly limited as long as the second heat treatment is performed in a reducing atmosphere.

For example, a heat treatment in a reducing gas atmosphere or a heat treatment in a state of being in contact with carbon is preferable, and the heat treatment in a state of being in contact with carbon is more preferable.

Reducing gas is preferably hydrogen (H₂) gas, carbon monoxide (CO) gas, and hydrocarbon gas (CₙH₂ₙ₊₁).

When the heat treatment is performed in the reducing gas atmosphere, mixed gas obtained by mixing the reducing gas with the other gas may be used. Examples of the other gas include nitrogen (N₂) gas and argon gas.

When N₂+H₂ gas is used as the mixed gas, the H₂ gas is preferably 1 vol % or more from the viewpoint of obtaining sufficient reducibility, and is preferably 4 vol % or less from the viewpoint of preventing a risk of explosion.

A heat treatment temperature T2 (° C.) in the second heat treatment is preferably higher than (Tg−200)° C., more preferably (Tg−150)° C. or higher, and still more preferably (Tg−120)° C. or higher, with respect to the glass transition temperature Tg (° C.) of the amorphous glass, from the viewpoint of obtaining sufficient reducing ability. From the viewpoint of preventing crystal growth, the heat treatment temperature T2 (° C.) is preferably lower than (Tg+200)° C., more preferably (Tg+150)° C. or lower, and still more preferably (Tg+100)° C. or lower.

By performing the second heat treatment in the reducing atmosphere, an amorphized region is formed on the surface layer of the glass ceramics. Although the details are not clear, it is presumed that this is because some atoms constituting the crystalline phase are reduced, and thus a crystalline state cannot be maintained.

The amorphized region may be formed on the surface layer of at least one main surface of the glass ceramic, but is preferably formed on surface layers of both main surfaces from the viewpoint of improving strength. In addition, the amorphized region may be formed not only on the surface layer of the main surface but also on a surface layer of an end surface.

The depth of the amorphized region from the outermost surface is preferably 10 μm or less, but the depth of the amorphized region can be adjusted by changing the temperature or reducing power of the second heat treatment.

The crystallinity at a depth of 100 nm from the outermost surface of the amorphized region is preferably 10 vol % or less. The crystallinity of the outermost surface of the amorphized region may be 0 vol %, that is, the entire amorphized region may be a glass phase.

The crystallinity in such an amorphized region and a profile of the crystallinity in a depth direction can be adjusted by controlling the temperature and atmosphere during the heat treatment of the glass ceramics in the reducing atmosphere.

When the chemically strengthened glass ceramics are used for an application of forming a three-dimensional shape of a cover glass or the like, the glass ceramics are preferably formed into a shape having a curved portion at the same time as the second heat treatment.

As a bending forming method for forming a shape having a curved portion, any method can be selected from existing bending methods such as a self-weight forming method, a vacuum forming method, and a press forming method. In addition, two or more kinds of bending forming methods may be used in combination.

The self-weight forming method is a method in which a glass ceramic sheet is placed on a shaping mold, and then the glass ceramic sheet is heated, made to conform to the shaping mold by gravity, and bent into a predetermined shape.

The vacuum forming method is a method in which a glass ceramic sheet is placed on a shaping mold, a periphery of the glass ceramic sheet is sealed, and then a space between the shaping mold and the glass ceramic sheet is depressurized, and a differential pressure is applied to the front and back surfaces of the glass ceramic sheet to bend the glass ceramic sheet. At this time, an upper surface side of the glass ceramic sheet may be supplementarily pressurized.

The press forming is a method in which a glass ceramic sheet is placed between a lower mold and an upper mold, which are shaping molds, and heated, and a press load is applied between the upper and lower shaping molds to bend the glass ceramic sheet into a predetermined shape.

All of the above bending forming methods are methods of deforming glass ceramics by applying a force in a heated state. In addition, it is preferable to use a shaping mold made of carbon during forming. This is because the carbon is brought into contact with the glass sheet to form a reducing atmosphere, and thus the reducing atmosphere in step (c) can be obtained and the forming can be performed at the same time. In the case of using the shaping mold made of carbon, when the shaping mold is pressed against both main surfaces of the glass ceramics from the outside, both main surfaces are uniformly amorphized, which is preferable in that the glass ceramics do not warp during the chemical strengthening treatment.

A bending (thermal bending) forming temperature is, for example, 700° C. to 1100° C., preferably 750° C. or higher, and preferably 1050° C. or lower. When the thermal bending temperature is higher than a maximum temperature of the heat treatment temperature in the crystallization treatment, that is, step (b), thermal deformation easily occurs, which is preferable from the viewpoint of dimensional accuracy. A difference between the maximum temperature of the crystallization treatment and the thermal bending temperature is preferably 10° C. or higher, and more preferably 30° C. or higher. On the other hand, from the viewpoint of preventing a decrease in light transmittance due to bending, the difference between the maximum temperature of the crystallization treatment and the thermal bending temperature is preferably 120° C. or lower, more preferably 100° C. or lower, still more preferably 90° C. or lower, and particularly preferably 60° C. or lower.

The decrease in light transmittance due to bending is preferably 3% or less, more preferably 2% or less, still more preferably 1.5% or less, and particularly preferably 1% or less.

In order to maintain high transparency of finally obtained glass ceramics, it is advantageous that the light transmittance before thermal bending is high, and the light transmittance in terms of a thickness of 0.7 mm is preferably 85% or more. The light transmittance is more preferably 87% or more, and particularly preferably 89% or more.

(Step (d))

By performing a chemical strengthening treatment on the glass ceramics obtained in step (c) in which the amorphized region is formed, chemically strengthened glass ceramics are obtained.

The chemical strengthening treatment is a treatment in which, by a method of immersing the glass ceramics in which the amorphized region is formed into a melt of a metal salt containing metal ions having a large ionic radius, the glass ceramics are brought into contact with the metal salt, and metal ions having a small ionic radius in the glass ceramics are substituted with the metal ions having a large ionic radius. Typically, Li ions are substituted with Na ions or K ions, and Na ions are substituted with K ions.

In order to increase a rate of the chemical strengthening treatment, it is preferable to use “Li-Na exchange” in which Li ions in the glass ceramics are exchanged with Na ions. In addition, in order to form a large compressive stress by ion exchange, it is preferable to use “Na-K exchange” in which Na ions in the glass ceramics are exchanged with K ions.

Examples of the molten salt for performing the chemical strengthening treatment include nitrate, sulfate, carbonate, and chloride. Examples of the nitrate include lithium nitrate, sodium nitrate, potassium nitrate, cesium nitrate, and silver nitrate. Examples of the sulfate include lithium sulfate, sodium sulfate, potassium sulfate, cesium sulfate, and silver sulfate. Examples of the carbonate include lithium carbonate, sodium carbonate, and potassium carbonate. Examples of the chloride include lithium chloride, sodium chloride, potassium chloride, cesium chloride, and silver chloride. One of these molten salts may be used alone, or a plurality thereof may be used in combination.

The treatment conditions such as the time and temperature of the chemical strengthening treatment may be appropriately selected in consideration of the glass composition, the type of molten salt, and the like.

The chemically strengthened glass ceramics may be obtained by, for example, the following two-stage chemical strengthening treatment.

As a first-stage chemical strengthening treatment, the glass ceramic in which the amorphized region is formed on the surface layer are immersed in a metal salt containing Na ions, for example, a sodium nitrate molten salt, at about 350° C. to 500° C. for about 0.1 to 10 hours. Accordingly, ion exchange occurs between Li ions in the glass ceramic and Na ions in the metal salt, and for example, a compressive stress layer having a surface compressive stress value of 200 MPa or more and a depth of compressive stress layer of 80 μm or more is formed. When the surface compressive stress value introduced in the first-stage treatment exceeds 1000 MPa, it may be difficult to increase the depth of compressive stress layer (DOL) while keeping an internal stress (CT) low in the finally obtained chemically strengthened glass ceramic. Therefore, the surface compressive stress value introduced in the first-stage treatment is preferably 900 MPa or less, more preferably 700 MPa or less, and still more preferably 600 MPa or less.

As a second-stage chemical strengthening treatment, the glass ceramic subjected to the first-stage treatment are immersed in a metal salt containing K ions, for example, a potassium nitrate molten salt, at about 350° C. to 500° C. for about 0.1 to 10 hours. Accordingly, a large compressive stress is generated in a portion of the compressive stress layer formed in the previous treatment, for example, at a depth of about 10 μm or less.

By such a two-stage chemical strengthening treatment, a preferable stress profile having a surface compressive stress value of 600 MPa or more is easily obtained.

In the two-stage chemical strengthening treatment, the glass ceramic may be first immersed in the metal salt containing Na ions, then held in the atmosphere at 350° C. to 500° C. for 1 to 5 hours, and then immersed in the metal salt containing K ions.

The holding temperature in the atmosphere is preferably 425° C. or higher, and more preferably 440° C. or higher, and is preferably 475° C. or lower, and more preferably 460° C. or lower. By holding the glass ceramic at a high temperature in the atmosphere, Na ions introduced from the metal salt into the glass ceramic by the first-stage treatment are thermally diffused in the glass ceramic, and a more preferable stress profile is formed.

Instead of immersing the glass ceramic in the metal salt containing Na ions and holding the glass ceramic in the atmosphere in the first-stage treatment, the glass ceramic may be immersed in a metal salt containing Na ions and Li ions, for example, a mixed molten salt of sodium nitrate and lithium nitrate at 350° C. to 500° C. for 0.1 to 20 hours.

By immersing the glass ceramic in the metal salt containing Na ions and Li ions, ion exchange between Na ions in the glass ceramic and Li ions in the metal salt occurs, a more preferable stress profile is formed, and thus the drop strength is increased. This corresponds to a three-stage chemical strengthening treatment.

When such two-stage or three-stage chemical strengthening treatment is performed, a treatment time is preferably 10 hours or less, more preferably 5 hours or less, and still more preferably 3 hours or less in total from the viewpoint of production efficiency. On the other hand, in order to obtain a desired stress profile, the treatment time is preferably 0.5 hours or more, and more preferably 1 hour or more in total.

The chemically strengthened glass ceramics according to the present embodiment obtained as described above may have a shape other than a sheet shape depending on an applicable product, a use, or the like. In addition, the chemically strengthened glass ceramics may have an edging shape in which the thicknesses of an outer periphery are different. The form of the chemically strengthened glass ceramics is not limited thereto, and for example, two main surfaces may not be parallel to each other, and all or a part of one or both of the two main surfaces may be curved surfaces. More specifically, the chemically strengthened glass ceramics may be, for example, a flat sheet-shaped glass sheet having no warpage or a curved glass sheet having a curved surface.

The chemically strengthened glass ceramics are particularly useful as a cover glass used for a mobile device such as a mobile phone and a smartphone. Furthermore, the chemically strengthened glass ceramics are also useful for a cover glass of a display device such as a television, a personal computer, or a touch panel, which is not intended to be carried. Further, the chemically strengthened glass ceramics are also useful for an elevator wall surface, or a wall surface of a construction such as a house and a building, that is, a full-screen display. In addition to the above, the chemically strengthened glass ceramics are also useful as a building material such as a window glass, a table top, an interior of an automobile, an airplane, or the like, and a cover glass thereof, or a casing having a curved surface shape.

### EXAMPLES

Hereinafter, the present invention will be described with reference to Examples, but the present invention is not limited thereto.

Examples 1 to 3 are Examples, and Examples 4 and 5 are Comparative Examples.

### Example 1

Glass raw materials were blended and mixed so as to result in a glass composition shown in Glass A of Table 1 in terms of mass % based on oxides. Next, the mixed glass raw materials were put into a platinum crucible, followed by being placed in an electric furnace at 1600° C., and were melted for about 4 hours, defoamed, and homogenized.

The obtained molten glass was poured into a mold, held at a temperature higher than a glass transition point by about 30° C., that is, 500° C. for 1 hour, and then cooled to room temperature at a rate of 0.5° C./min to obtain a glass block. The obtained glass block was processed into a sheet shape of about 60 mm×60 mm×0.7 mm to obtain an amorphous glass having two main surfaces opposed to each other.

Next, as a first heat treatment, the amorphous glass was held at 550° C. for 2 hours and then held at 730° C. for 2 hours to perform a crystallization treatment, thereby obtaining a glass A as glass ceramic.

Next, as a second heat treatment, a heat treatment was performed at 690° C. for 3 minutes in a 98 vol % N₂-2 vol % H₂ gas atmosphere to form an amorphized region on a surface layer of the main surface.

Thereafter, the glass was immersed in a sodium nitrate molten salt at 450° C. for 2.4 hours for chemical strengthening treatment to obtain chemically strengthened glass ceramic. A blank column in the glass composition shown in Table 1 means that the content of such a component is less than a detection limit value.

### Example 2

A chemically strengthened glass ceramic was prepared in the same manner as in Example 2, except that as a second heat treatment, a shaping mold made of carbon was pressed from the outside of both main surfaces of the glass to bring the shaping mold into contact with the glass, thereby forming a reducing atmosphere. In this state, a heat treatment was performed at 690° C. for 3 minutes so that amorphized regions were formed on the surface layers of both main surfaces. By using the shaping mold made of carbon, an end portion of the obtained glass was processed into a three-dimensional shape having a curved portion.

### Example 3

Glass raw materials were blended and mixed so as to result in a glass composition shown in Glass B of Table 1 in terms of mol % based on oxides. Next, the mixed glass raw materials were put into a platinum crucible, followed by being placed in an electric furnace at 1600° C., and were melted for about 4 hours, defoamed, and homogenized. The obtained molten glass was poured into a mold, held at a temperature higher than a glass transition point by about 30° C., that is, 745° C. for 1 hour, and then cooled to room temperature at a rate of 0.5° C./min to obtain a glass block. The obtained glass block was processed into a sheet shape of about 60 mm×60 mm×0.7 mm to obtain an amorphous glass having two main surfaces opposed to each other.

Next, as a first heat treatment, the amorphous glass was held at 750° C. for 4 hours and then held at 900° C. for 4 hours to perform a crystallization treatment, thereby obtaining a glass B as glass ceramic.

Next, as a second heat treatment, a shaping mold made of carbon was pressed from the outside of both main surfaces of the glass to bring the shaping mold into contact with the glass, thereby forming a reducing atmosphere. In this state, a heat treatment was performed at 787° C. for 6 minutes to form amorphized regions on the surface layers of both main surfaces. By using the shaping mold made of carbon, an end portion of the obtained glass was processed into a three-dimensional shape having a curved portion.

Thereafter, the glass was immersed in a sodium nitrate molten salt at 450° C. for 0.5 hours, and then immersed in a potassium nitrate molten salt at 450° C. for 1 hour to perform a two-stage chemical strengthening treatment, thereby obtaining chemically strengthened glass ceramic.

### Example 4

Chemically strengthened glass ceramic was obtained in the same manner as in Example 1, except that a second heat treatment was performed under the atmosphere.

### Example 5

Chemically strengthened glass ceramic was obtained in the same manner as in Example 3, except that a second heat treatment was performed under the atmosphere without bringing a shaping mold made of carbon into contact with the glass.

### <Evaluation Method>

### (Glass Transition Temperature Tg (° C.))

As for the amorphous glass and the glass ceramic after the first heat treatment, a thermal expansion curve was obtained at a temperature rising rate of 10° C./min using a thermal dilatometer (TD5000SA, manufactured by Bruker AXS Inc.) in accordance with JIS R1618:2002. The glass transition temperature Tg (° C.) was determined based on the obtained thermal expansion curve. The results are shown in Table 1.

### (Crystallinity (Vol %))

The crystallinity of the glass was calculated from a TEM image obtained by observation with a transmission electron microscopy (EM-2010F, TEM manufactured by JEOL Ltd.).

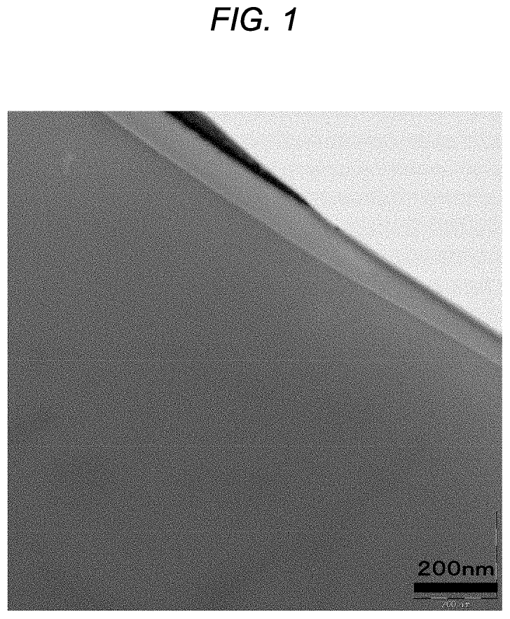

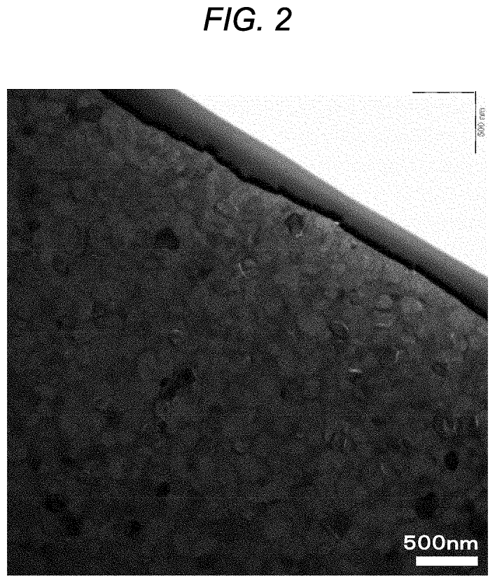

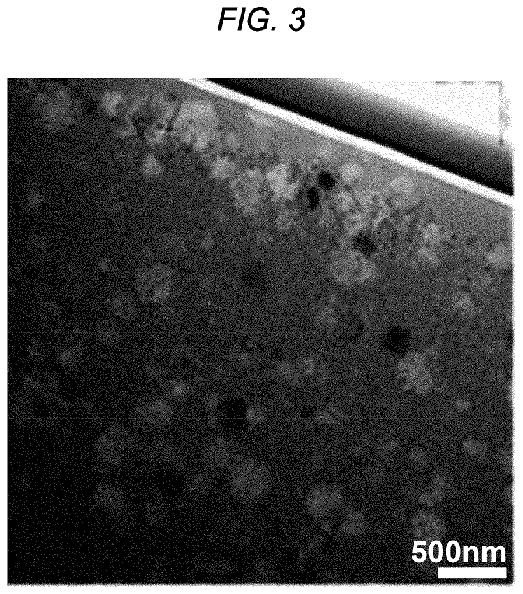

As an example of the TEM image, in Example 3, a TEM image of the amorphous glass before being subjected to the first heat treatment is shown in FIG. 1, a TEM image of the glass ceramic obtained after the first heat treatment is shown in FIG. 2, and a TEM image of the glass ceramic obtained after the second heat treatment is shown in FIG. 3.

A region having a uniform structure, which occupies most of FIG. 1, is the glass. A light color region located on a surface of the glass and a black color region located on a surface of the light color region are a carbon coat layer formed by carbon vapor deposition and a Pt coat layer formed by platinum sputtering, respectively, which were performed in TEM observation. It was confirmed that the glass in FIG. 1 had a uniform structure without a clear boundary in shading, and had only a glass phase, that is, an amorphous phase without a crystalline phase.

Further, a region occupying most of FIG. 2 is the glass, but unlike FIG. 1, dark dots and a granular region having a clear boundary were confirmed. The dark dots are crystal nuclei, and the granular region having a clear region is a crystalline phase.

Based on the differences in FIG. 2, in FIG. 3 showing the glass ceramic obtained after the second heat treatment in Example 3, there is no clear boundary in shading from the surface layer of the glass in contact with the black region which is the Pt coat layer toward a certain depth. Therefore, it can be seen that the surface layer of the main surface of the glass has no crystalline phase, or has a slight crystalline phase, and an amorphized region is formed.

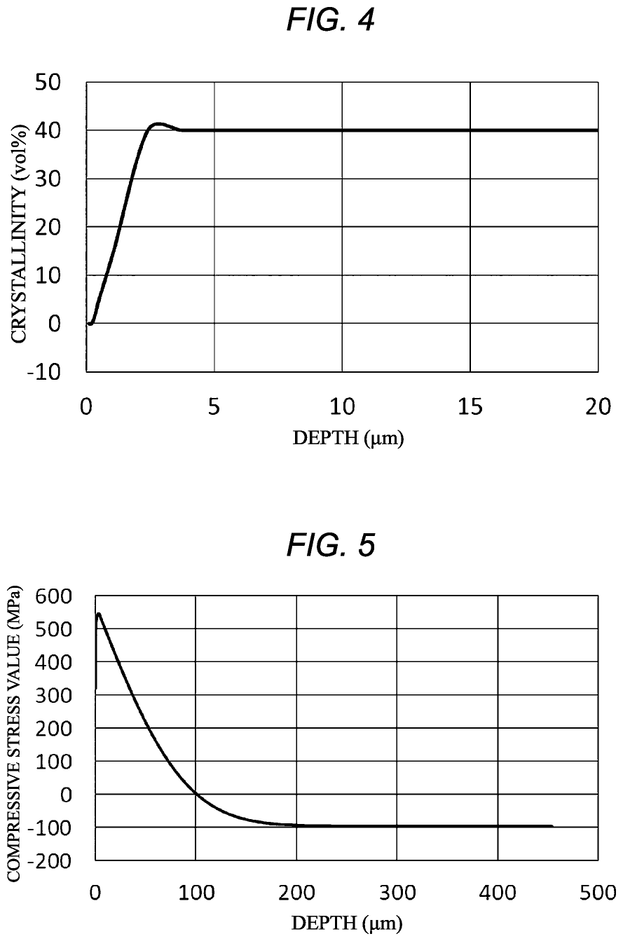

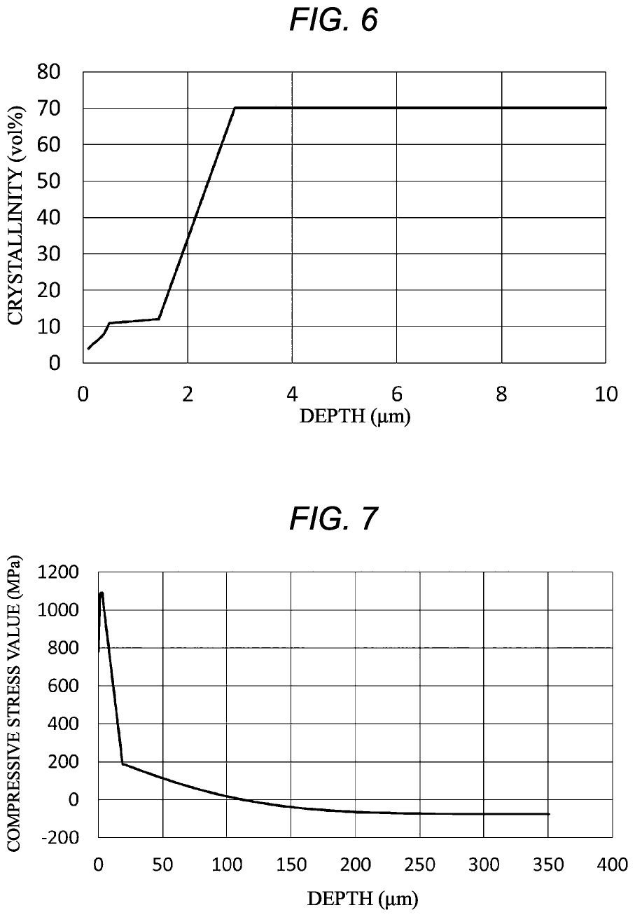

Regarding the chemically strengthened glass ceramics, for a depth of 100 nm to 500 nm from the outermost surface, the crystallinity at each target depth was calculated for each depth of 100 nm, and for a depth of 500 nm or more, the crystallinity at each target depth was calculated by setting any depth as a target depth. Specifically, in a TEM image of a target depth portion, a total length X gm of crystalline phases present in a range of 1 μm in a direction parallel to any main surface and 0.05 μm in a depth direction was measured, and a value represented by (X/0.05) was defined as the crystallinity (vol %). As an example, relationships between the crystallinity and the depth from the outermost surface of the chemically strengthened glass ceramics of Examples 2 and 3 are shown in FIG. 4 and FIG. 6, respectively.

A value at which the crystallinity is constant in the depth direction is the average crystallinity of the crystallized region of the chemically strengthened glass ceramics in which the amorphized region is formed on the surface layer, and is the same as the crystallinity of glass ceramics before the amorphized region is formed.

In the chemically strengthened glass ceramics, a depth at which the crystallinity was 10 vol % was defined as a depth of the amorphized region. These results are shown in Table 2 together with the crystallinity at a depth of 100 nm from the outermost surface.

### (Sodium Concentration (mol %))

Regarding the chemically strengthened glass ceramics of Examples 1 to 5, a sodium concentration [Na] in a depth region of 230 μm or more from the outermost surface was measured by an electron probe microanalyzer (JXA-8500F, EPMA manufactured by JEOL Ltd.).

Regarding the chemically strengthened glass ceramic of Example 2, a sodium concentration [Na]₀ at a depth of 10 nm from the outermost surface was measured using an X-ray photoelectron spectrometer (ESCA5500, XPS manufactured by ULVAC-PHI, Inc.). XPS measurement conditions were as follows.

Detection Region: 800 μmφ; Detection Angle: 75 deg with respect to a sample surface; Pass Energy: 117.4 eV; Energy Step: 0.5 eV/step; Sputtering Ion Type: C₆₀⁺; Sputtering Setting: voltage 10 kV; Raster Size: 3×3.5 mm²; and Measurement Interval: 2 minutes

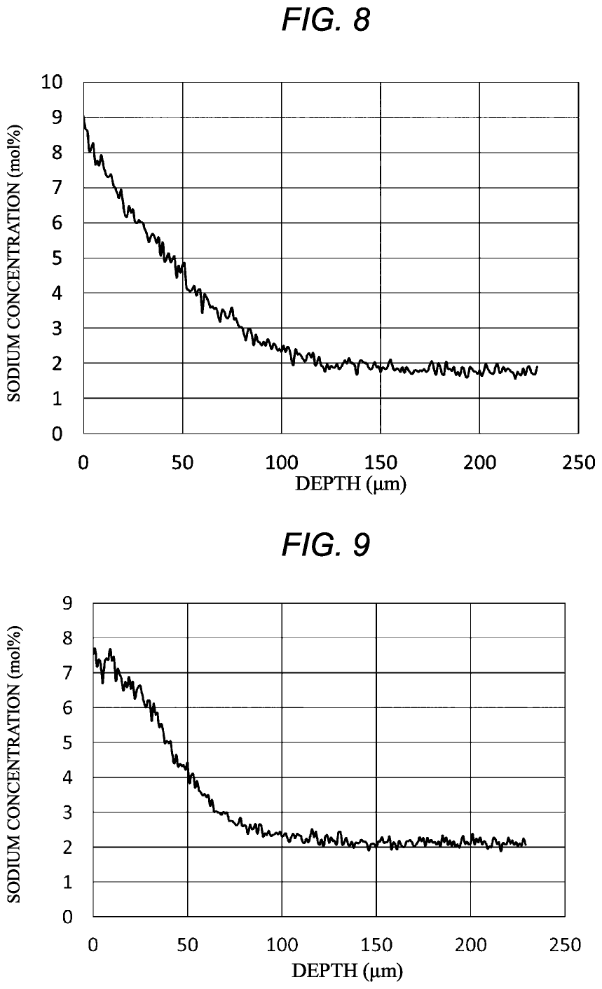

As an example, relationships between the sodium concentration and the depth from the outermost surface of the chemically strengthened glass ceramics of Examples 2 and 3 are shown in FIG. 8 and FIG. 9, respectively.

The sodium concentration at the depth of 10 nm from the outermost surface, which is calculated by fitting a sodium concentration profile in a region at a depth of 10 to 200 μm from the outermost surface to the following formula (1) by a least squares method, is shown as [Na]_{c} in Table 2.

In Example 2, the sodium concentration [Na]₀ (mol %) at the depth of 10 nm from the outermost surface obtained from the results of the XPS measurement, an absolute value of a sodium concentration difference represented by |[Na]₀-[Na]_{c}|, and a ratio of [Na]₀ to [Na]_{c} are also shown in Table 2.

y=A×erfc(x×B)+C (1)

(In the formula, y is a sodium concentration (mol %), x is a depth (μm) from the outermost surface, erfc is a complementary error function, A, B, and C are constants, and x satisfies 0≤x≤200.)

Constants in the formula (1) in Example 1 were A=6.712, B=0.012, and C=1.521. Constants in the formula (1) in Example 2 were A=6.799, B=0.011, and C=1.546. Constants in the formula (1) in Example 3 were A=6.844, B=0.014, and C=1.849. Constants in the formula (1) in Example 4 were A=6.521, B=0.009, and C=1.621. Constants in the formula (1) in Example 5 were A=6.831, B=0.014, and C=1.802.

### (Crystalline Phase)

The chemically strengthened glass ceramics were subjected to powder X-ray diffraction (SmartLab, XRD manufactured by Rigaku Corporation) measurement to identify a crystalline phase. Measurement conditions were as follows: X-ray Source: CuKα ray; Measurement Range: 2θ=10° to 80° ; Scan Speed: 10°/min; and Step Width: 0.02°. The results are shown in Table 2. The crystalline phase of the chemically strengthened glass ceramics can be regarded as the same as the crystalline phase of the glass ceramics. The first ionization energy of a part of elements constituting the crystalline phase is shown below.

Li=5.4 eV, Na=5.2 eV, Al=6.0 eV, Si=8.2 eV

### (Compressive Stress Value (CS))

A stress profile of chemically strengthened glass ceramics at a depth of 10 μm or more from the outermost surface was measured using a surface stress meter (FSM-6000, manufactured by Orihara Industrial Co., Ltd.) and a measuring instrument (SLP1000, manufactured by Orihara Industrial Co., Ltd.) applying scattered light photoelasticity.

Each of compressive stress values at the outermost surface and at a depth of less than 10 μm from the outermost surface was calculated by converting a curvature radius of warpage based on an amount of warpage generated by etching only one main surface of a pair of opposing main surfaces into a stress using the following formula shown in the following reference document.

Specifically, glass was immersed in an acid of 1% HF-99% H₂O (volume fraction) in a state where one main surface is sealed, and only the other main surface was etched to any thickness. Accordingly, a stress difference occurs between front and back surfaces of the chemically strengthened glass ceramic, and the glass warps in accordance with the stress difference. The amount of warpage was measured using a contact type shape measuring device (Surftest manufactured by Mitutoyo Corporation).

CS₀=Et²/6(1−v)Rt′

(In the formula, E is a Young's modulus of the glass, t is a thickness of the glass, v is a

Poisson's ratio of the glass, R is a curvature radius of warpage of the glass, and t′ is a thickness of an etched portion.)

(Reference Document: G. G. Stoney, Proc. Roy. Soc. A82, 172 (1909))

As examples obtained as described above, the stress profiles of the chemically strengthened glass ceramics of Examples 2 and 3 are shown in FIG. 5 and FIG. 7, respectively.

A compressive stress value CS₀ at the outermost surface on which the amorphized region is formed, a compressive stress value CS₅ at a depth of 5 μm from the outermost surface, a compressive stress value CS₅₀ at a depth of 50 μm from the outermost surface, and a maximum value (CSₘₐₓ) of the compressive stress value, and a depth from the outermost surface at which CSₘₐₓ is obtained, which are obtained from the stress profiles, are shown in Table 2.

### (Sodium Ion Diffusion Depth)

The sodium ion diffusion depth of the chemically strengthened glass ceramics was measured using an electron probe microanalyzer (DCA-8500F, EPMA manufactured by JEOL Ltd.). Although it is difficult to accurately measure the sodium concentration of the outermost surface by EPMA, there is no significant influence on the measurement of the sodium ion diffusion depth corresponding to the depth of compressive stress layer (DOL). The results are shown in Table 2.

### (Four-Point Bending Strength)

The four-point bending strength was measured by performing a four-point bending test under the conditions of a distance between outer fulcrums of a holder of 30 mm, a distance between inner fulcrums of the holder of 10 mm, and a crosshead speed of 0.5 mm/min, and the four-point bending strength was measured. The number of test pieces was 10, and the average strength thereof was taken as the four-point bending strength. The results are shown in Table 2.

### (Drop Strength)

The chemically strengthened glass ceramics were cut into a test piece of 120 mm×60 mm×0.7 mm, which was regarded as a cover glass of a smartphone. The test piece was attached to a housing that simulates a smartphone, and was dropped onto a flat surface on which 180 grit sandpaper is placed. At this time, the total mass of the test piece and the housing was about 140 g. A drop test was started from a height of 30 cm, and when a glass sheet as the test piece did not break, the drop test was repeated by increasing the height by 10 cm, and a height when the glass sheet broke was recorded. The test was counted as one set, 10 sets were repeated, and an average value of heights when the glass sheet broke was defined as the drop strength. The results are shown in Table 2.

### (Chipping Probability)

Each 100 sheets of the chemically strengthened glass ceramics obtained by the chemical strengthening treatment were allowed to stand for 24 hours. After standing, a probability of occurrence of chipping was calculated based on the number of samples in which chipping was observed on end surface. The results are shown in Table 2.

TABLE 1

| | | Glass A | Glass B |
|---|---|---|---|
| Composition | SiO₂ | 48.4 | 61.1 |
| (mass %) | P₂O₅ | 10.6 | 5.8 |
| | Al₂O₃ | 8.2 | 21.8 |
| | Li₂O | 16.4 | 4.2 |
| | Na₂O | 1.8 | 1.9 |
| | K₂O | 1.8 | |
| | SrO | | 1.0 |
| | ZrO₂ | 9.0 | 2.2 |
| | SnO₂ | | 2.0 |
| | Y₂O₃ | 3.6 | |

| | | |
|---|---|---|
| First Heat Treatment | 550° C.-2 hours | 750° C.-4 hours |
| (Crystallization Treatment) | → 730° C.-2 hours | → 900° C.-4 hours |
| Conditions | | |
| Tg (Amorphous Glass) (° C.) | 471 | 714 |
| Tg (Glass Ceramic) (° C.) | 610 | 900 |
| Crystallinity (vol % ) | 40% | 70% |

TABLE 2

| | | Example 1 | Example 2 | Example 3 |
|---|---|---|---|---|
| Glass Ceramics | | Glass A | Glass A | Glass B |
| Second | Heat Treatment | 98% N₂-2% H₂ Gas | Carbon Contact | Carbon Contact |
| Heat | Atmosphere | | | |
| Treatment | Heat Treatment | 690° C. | 690° C. | 787° C. |
| | Temperature | (Tg + 80° C.) | (Tg + 80° C.) | (Tg − 113° C.) |
| | Heat Treatment | 3 minutes | 3 minutes | 6 minutes |
| | Time | | | |

| | | | |
|---|---|---|---|
| Chemical Strengthening | NaNO₃ 99.7% − | NaNO₃ 99.7% − | NaNO₃100% − |
| Treatment | 450° C. − 2.4 hours | 450° C. − 2.4 hours | 450° C. − 0.5 hours |
| | | | → KNO₃ 100% − |
| | | | 450° C. − 1 hour |
| Crystallinity at Depth of | 8% | 3% | 5% |
| 100 nm from Outermost | | | |
| Surface (vol %) | | | |
| Depth of Amorphized | 0.6 μm | 0.8 μm | 0.47 μm |
| Region (μm) | | | |
| Average Crystallinity of | 40% | 40% | 70% |
| Crystallized Region | | | |
| (vol %) | | | |
| [Na]₀ (mol %) | — | 9.2 | — |
| [Na]_{c} (mol %) | 8.21 | 8.34 | 8.69 |
| [Na]₀ − [Na]_{c} (mol %) | — | 0.86 | — |
| [Na]₀/[Na]_{c} | — | 1.10 | — |
| Crystalline Phase | Li, Si, P, Al, | Li, Si, P, Al, | Li, Si, P, Al, |
| | Li, Na, K | Li, Na, K | Li, Na |
| CS₀ (MPa) | 452 | 312 | 780 |
| CS₅ (MPa) | 552 | 557 | 1008 |
| CS₅₀ (MPa) | 205 | 213 | 118 |
| CSₘₐₓ, Depth (MPa, μm) | 654 MPa, 4.4 μm | 657 MPa, 5.0 μm | 1092 MPa, 2.9 μm |
| Sodium Ion Diffusion | 91 | 97 | 112 |
| Depth (μm) | | | |
| Four-Point Bending | 568 | 573 | 1034 |
| Strength (MPa) | | | |
| Drop Strength (cm) | 156 | 161 | 165 |
| Chipping Probability (%) | 0% | 0% | 0% |

| | | Example 4 | Example 5 |
|---|---|---|---|
| Glass Ceramics | | Glass A | Glass B |
| Second | Heat Treatment | Atmosphere | Atmosphere |
| Heat | Atmosphere | | |
| Treatment | Heat Treatment | 690° C. | 787° C. |
| | Temperature | (Tg + 80° C.) | (Tg − 113° C.) |
| | Heat Treatment | 3 minutes | 6 minutes |
| | Time | | |

| | | |
|---|---|---|
| Chemical Strengthening | NaNO₃ 100% − | NaNO₃ 100% − 450° C. − 0.5 |
| Treatment | 450° C. − 1.5 hours | hours → KNO₃ 100% − |
| | | 450° C. − 1 hour |
| Crystallinity at Depth of | 40% | 70% |
| 100 nm from Outermost | | |
| Surface (vol %) | | |
| Depth of Amorphized | 0 μm | 0 μm |
| Region (μm) | | |
| Average Crystallinity of | 40% | 70% |
| Crystallized Region | | |
| (vol %) | | |
| [Na]₀ (mol %) | — | — |
| [Na]_{c} (mol %) | 8.45 | 7.86 |
| [Na]₀ − [Na]_{c} (mol %) | — | — |
| [Na]₀/[Na]_{c} | — | — |
| Crystalline Phase | Li, Si, P, Al, | Li, Si, P, Al, Li, Na |
| | Li, Na, K | |
| CS₀ (MPa) | 710 | 1207 |
| CS₅ (MPa) | 643 | 993 |
| CS₅₀ (MPa) | 146 | 105 |
| CSₘₐₓ, Depth (MPa, μm) | 710 MPa, 0 μm | 1207 MPa, 0 μm |
| Sodium Ion Diffusion | 67 | 108 |
| Depth (μm) | | |
| Four-Point Bending | 662 | 1012 |
| Strength (MPa) | | |
| Drop Strength (cm) | 107 | 143 |
| Chipping Probability (%) | 2% | 4% |

From the above results, it was found that the amorphized region was formed on the surface layer of the glass ceramics by performing the second heat treatment on the glass ceramics in a reducing atmosphere. Due to the presence of the amorphized region, the chemical strengthening properties for the subsequent chemical strengthening treatment were excellent, and the ion diffusion rate toward the inside of the glass was improved, and as a result, an internal compressive stress at a depth of 5 μm or 50 μm from the outermost surface was improved. In addition, it is found that the compressive stress value of the outermost surface of the chemically strengthened glass ceramics according to the present embodiment is smaller than that of the glass ceramics having no amorphized region, and the surface stress is relaxed. Accordingly, it is possible to prevent chipping after the chemical strengthening treatment while realizing excellent strength properties of the glass ceramics by the chemical strengthening treatment.

Although the present invention has been described in detail with reference to specific embodiments, it will be apparent to those skilled in the art that various changes and modifications can be made without departing from the spirit and scope of the present invention. The present application is based on Japanese Patent Application (No. 2020-130798) filed on Jul. 31, 2020, contents of which are incorporated herein by reference.

1. A chemically strengthened glass ceramic comprising a crystalline phase,
having two main surfaces opposed to each other, and
comprising an amorphized region in a surface layer of at least one of the main surfaces and a crystallized region inside the glass,
wherein the amorphized region has a crystallinity of 10 vol % or less at a depth of 100 nm from an outermost surface of the glass.

2. The chemically strengthened glass ceramic according to claim 1, further comprising sodium,
wherein an absolute value of a sodium concentration difference obtained by |[Na]₀-[Na]_{c}| is 10 mol % or less, where a sodium concentration at a depth of 10 nm from the outermost surface is defined as [Na]₀ (mol %) and a sodium concentration at the depth of 10 nm from the outermost surface, which is calculated by fitting a sodium concentration profile in a region at a depth of 10 μm to 200 μm from the outermost surface to the following formula (1) by a least squares method, is defined as [Na]_{c},
y=A×erfc(x×B)+C (1)
provided that y is a sodium concentration (mol %), x is a depth (μm) from the outermost surface, erfc is a complementary error function, A, B, and C are constants, and x satisfies 0≤x≤200.

3. The chemically strengthened glass ceramic according to claim 1, wherein the crystallized region has an average crystallinity of 20 vol % to 80 vol %.

4. The chemically strengthened glass ceramic according to claim 1, wherein the amorphized region has a depth of 10 μm or less.

5. The chemically strengthened glass ceramic according to claim 1, wherein the outermost surface has a compressive stress value CS₀ of 200 MPa to 900 MPa.

6. The chemically strengthened glass ceramic according to claim 1, wherein a depth from the outermost surface at which a compressive stress value CS is maximum is 0.1 μm to 10 μm.

7. The chemically strengthened glass ceramic according to claim 2, wherein a sodium ion diffusion depth is (t×0.05) μm to (t×0.2) μm with respect to a thickness t μm of the glass.

8. The chemically strengthened glass ceramic according to claim 1, wherein the crystalline phase comprises an atom having a first ionization energy of 8 eV or less.

9. The chemically strengthened glass ceramic according to claim 1, further comprising, in terms of mass % based on oxides:
45% to 75% of SiO₂;
1% to 30% of Al₂O₃;
1% to 25% of Li₂O;
0% to 15% of Na₂O;
0% to 8% of K₂O;
0% to 15% of at least one of SnO₂ and ZrO₂ in total; and
0% to 15% of P₂O₅.

10. A method for producing a chemically strengthened glass ceramic, the method comprising followings in order:
preparing an amorphous glass;
subjecting the amorphous glass to a first heat treatment to obtain a glass ceramic comprising a crystalline phase;
subjecting the glass ceramic to a second heat treatment in a reducing atmosphere to obtain a glass ceramic in which an amorphized region is formed on a surface layer of at least one main surface; and
chemically strengthening the glass ceramic in which the amorphized region is formed.

11. The method for producing a chemically strengthened glass ceramic according to claim 10, wherein the amorphized region is formed in a region having a depth of 10 μm or less from an outermost surface of the glass, and the amorphized region has a crystallinity of 10 vol % or less at a depth of 100 nm from the outermost surface.

12. The method for producing a chemically strengthened glass ceramic according to claim 10, wherein the glass ceramic obtained by the first heat treatment has an average crystallinity of 20 vol % to 80 vol %.

13. The method for producing a chemically strengthened glass ceramic according to claim 10, wherein the amorphous glass has a glass transition temperature Tg of 550° C. or less.

14. The method for producing a chemically strengthened glass ceramic according to claim 10, wherein a heat treatment temperature T2 (° C.) in the second heat treatment satisfies a relationship of (Tg−200)° C.<T2<(Tg+200)° C. with respect to the glass transition temperature Tg (° C.) of the amorphous glass.

15. The method for producing a chemically strengthened glass ceramic according to claim 10, wherein the second heat treatment is performed in a state where carbon is in contact with the glass ceramic.

16. The method for producing a chemically strengthened glass ceramic according to claim 10, wherein the glass is formed into a shape having a curved portion during the second heat treatment.

17. The method for producing a chemically strengthened glass ceramic according to claim 10, wherein the crystalline phase comprises an atom having an ionization energy of 8 eV or less.

18. The method for producing a chemically strengthened glass ceramic according to claim 10, wherein the amorphous glass comprises, in terms of mass % based on oxides:
45% to 75% of SiO₂;
1% to 30% of Al₂O₃;
1% to 25% of Li₂O;
0% to 15% of Na₂O;
0% to 8% of K₂O;
0% to 15% of at least one of SnO₂ and ZrO2 in total; and
0% to 15% of P₂O₅.
